(19) United States
(12) Patent Application Publication
(10) Pub. No.: US 2018/0113259 A1
(43) Pub. Date: Apr. 26, 2018

(54) PLUG-IN DEVICE

(71) Applicant: Amphenol Fiber Optic Technology (Shenzhen) Co., Ltd., Shenzhen City (CN)

(72) Inventors: Linghua ZHU, Shenzhen City (CN); Songsheng LI, Shenzhen City (CN); Xuewu LEI, Shenzhen City (CN); Jinan ZHOU, Shenzhen City (CN)

(21) Appl. No.: 15/443,462

(22) Filed: Feb. 27, 2017

(30) Foreign Application Priority Data
Oct. 26, 2016 (TW) 105216248

(51) Int. Cl. G02B 6/38

(52) U.S. Cl. CPC G02B 6/3825; G02B 6/3879; G02B 6/3898; G02B 6/3893

(57) ABSTRACT

A plug-in device is adapted for being sleeved onto an optical fiber connector. The optical fiber connector is connected to a terminal unit, and includes a connector body extending in a front-to-rear direction along an axis, and disposed for receiving at least one optical fiber, and a sleeve body sleeved on the connector body. The plug-in device includes a main body adapted to removably hold the sleeve body of the optical fiber connector, and formed with a receiving space, and a handle rod fixedly connected to and extending rearwardly from the main body, and adapted for being gripped by an operator.

### CROSS-REFERENCE TO RELATED APPLICATION

This application claims priority of Taiwanese Patent Application No. 105216248, filed on Oct. 26, 2016.

### FIELD

The disclosure relates to a device for use with an optical fiber connector, and more particularly to a plug-in device of the optical fiber connector.

### BACKGROUND

In many types of optical fiber connectors, SC connectors (Subscriber Connector/Standard Connector) are often mounted for use of customers and are connected with an optical fiber connector in a snap-fit manner. As shown in FIG. 1, a conventional SC connector 1 includes a connector body 11 disposed for receiving at least one optical fiber, a sleeve body 12 sleeved on the connector body 11, and a tail cover 13 connected to and disposed behind the connector body 11. The SC connector 1 is connected to a terminal unit (not shown) through the sleeve body 12. Since the requirement for communication speed is increased, the density of a plurality of optical fibers for use of the customers is also increased. When an operator needs to plug or unplug the SC connector 1 with one hand, he or she needs to first hold the sleeve body 12 with fingers of the other hand, thereby allowing a force is applied to plug or unplug the SC connector 1. However, when a plurality of SC connectors 1 are required to be connected to the terminal unit, the SC connectors 1 are disposed proximate to each other, and an operation space for the operator is small. As a result, a plug-unplug operation becomes difficult for the user.

### SUMMARY

Therefore, the object of the disclosure is to provide a plug-in device that is easier to be operated by a user.

According to the disclosure, the plug-in device is adapted for being sleeved onto an optical fiber connector. The optical fiber connector is connected to a terminal unit, and includes a connector body extending in a front-to-rear direction along an axis, and is disposed for receiving at least one optical fiber, and a sleeve body sleeved on the connector body. The plug-in device includes a main body adapted to removably hold the sleeve body of the optical fiber connector, and formed with a receiving space, and a handle rod fixedly connected to and extending rearwardly from the main body, and adapted for being gripped by an operator.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional SC connector;

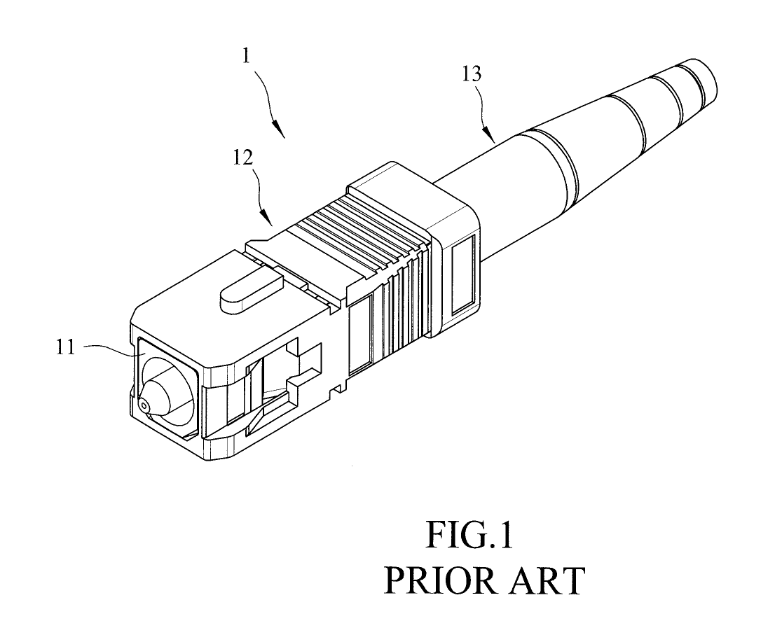

FIG. 2 is a perspective view of a first embodiment of a plug-in device according to the disclosure;

FIG. 3 is a perspective exploded view of the first embodiment and an optical fiber connector;

FIG. 4 is a perspective view of the first embodiment and the optical fiber connector;

FIG. 5 is a sectional view of the first embodiment and the optical fiber connector;

FIG. 6 is a perspective view of a second embodiment of the plug-in device according to the disclosure;

FIG. 7 is a perspective exploded view of the second embodiment and two optical fiber connectors; and

FIG. 8 is a perspective view of the second embodiment and the optical fiber connectors.

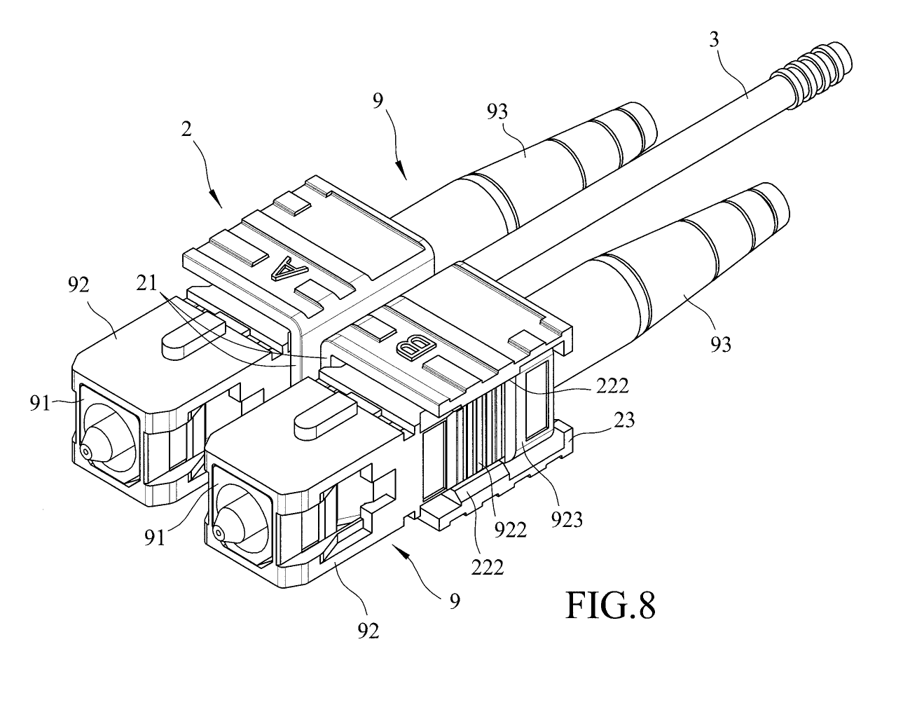

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

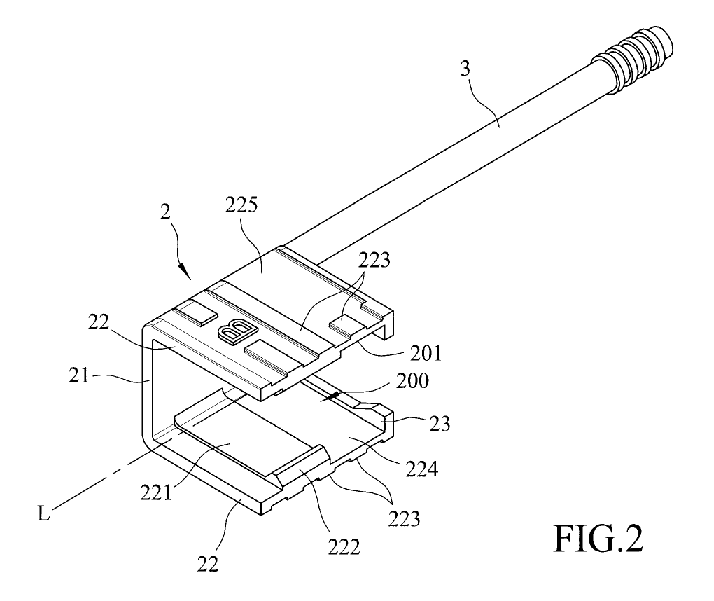

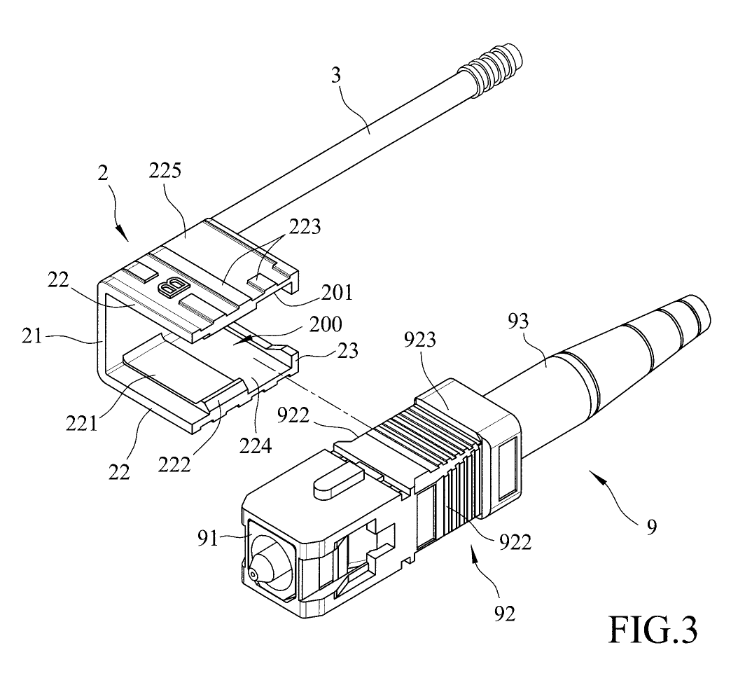

Referring to FIGS. 2 and 3, the first embodiment of a plug-in device according to the disclosure is adapted for being sleeved onto an optical fiber connector 9. The optical fiber connector 9 is connected to a terminal unit (not shown), and includes a connector body 91 extending in a front-to-rear direction along an axis (L), and disposed for receiving at least one optical fiber, a sleeve body 92 sleeved on the connector body 91, and a tail cover 93 extending rearwardly from the sleeve body 92. The sleeve body 92 has a coupling portion 922 disposed on a surrounding surface of the sleeve body 92, and a protrusion 923 protruding from the surrounding surface of the sleeve body 92, and connected to and disposed behind the coupling portion 922.

The plug-in device includes a main body 2 adapted to removably hold the sleeve body 92 of the optical fiber connector 9, and a handle rod 3 fixedly connected to and extending rearwardly from the main body 2.

The main body 2 is formed with a receiving space 200, and has a side plate 21, two holding plates 22 spaced apart from each other, and respectively and perpendicularly extending from two opposite ends of the side plate 21, and at least one end plate 23 extending perpendicularly from a rear end of one of the holding plates 22 toward the receiving space 200. This embodiment includes two end plate 23 extend from rear ends of the holding plates 22, respectively, and may be varied in other embodiments. The holding plates 22 respectively have distal ends that cooperate to define a lateral opening 201 therebetween, which is in spatial communication with the receiving space 200. The receiving space 200 is surrounded by the side plate 21 and the holding plates 22. The lateral opening 201 is spaced apart from the side plate 21 and is adapted to permit the sleeve body 92 of the optical fiber connector 9 to be inserted into the receiving space 200 through the lateral opening 201 during assembly of the plug-in device to the optical fiber connector 9. Each of the holding plates 22 has an inner surface 224 facing the receiving space 200, an outer surface 225 disposed opposite to the inner surface 224, a guiding portion 221 extending from the inner surface 224 toward the receiving space 200, a retaining portion 222 protruding from one end of the guiding portion 221 that is distal from the side plate 21 toward the receiving space 200, and a plurality of projections 223 disposed on the outer surface 225, and spaced apart from each other along the axis (L).

The handle rod 3 extends rearwardly along the axis (L) from a rear end of the side plate 21, and is adapted for being gripped by an operator.

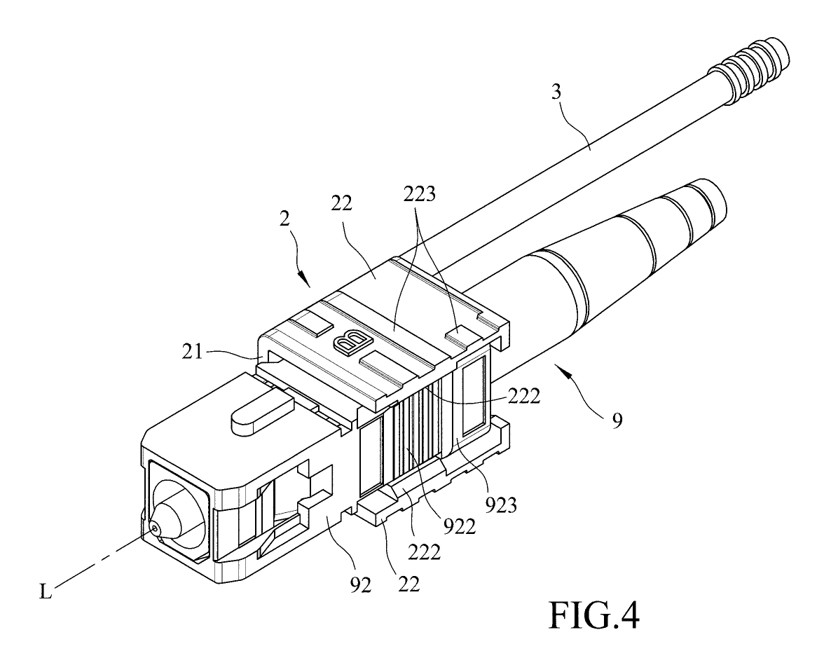

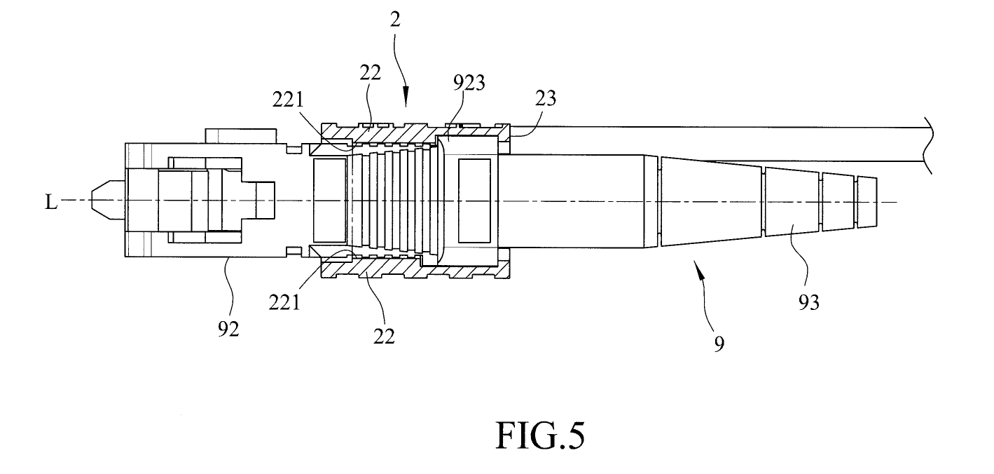

Referring to FIGS. 3 to 5, during the assembly of the plug-in device to the optical fiber connector 9, the sleeve body 92 of the optical fiber connector 9 is inserted into the receiving space 200 through the lateral opening 201 of the main body 2 and moves in a direction which is perpendicular to the axis (L). At this moment, the guiding portions 221 of the holding plates 22 and the end plate 23 confine the protrusion 923 of the sleeve body 92 thereamong. The assembly of the plug-in device to the optical fiber connector 9 is not completed until the coupling portion 922 of the sleeve body 92 is confined between the retaining portions 222 of the base plates 22 and the side plate 21. It should be noted that, the disposition of the projections 223 of the main body 2 is for increasing the friction between the main body 2 and a hand of the operator during the assembly of the plug-in device to the optical fiber connector 9. In addition, it should be also noted that, as shown in FIG. 5, the guiding portions 221 of the holding plates 22 have different lengths along the axis (L) such that, an artificial negligence can be prevented, thereby achieving a fool-proof function.

To connect the optical fiber connector 9 to the terminal unit or a relaying unit, the operator needs to hold the handle rod 3 and then applies a pushing force to the handle rod 3 along the axis (L). In such manner, since the end plate 23 of the main body 2 abuts against a rear end of the sleeve body 92 of the optical fiber connector 9, the optical fiber connector 9 also moves forwardly with the main body 2 when the main body 2 is pushed by the pushing force to move forwardly. To disconnect the optical fiber connector 9 from the terminal unit or the relaying unit, the operator needs to hold the handle rod 3 and then applies a pulling force to the handle rod 3 along the axis (L). In such manner, since the guiding portions 221 of the main body 2 abut against a front end of the protrusion 923 of the optical fiber connector 9, the optical fiber connector 9 also moves rearwardly with the main body 2 when the main body is pulled by the pulling force to move rearwardly.

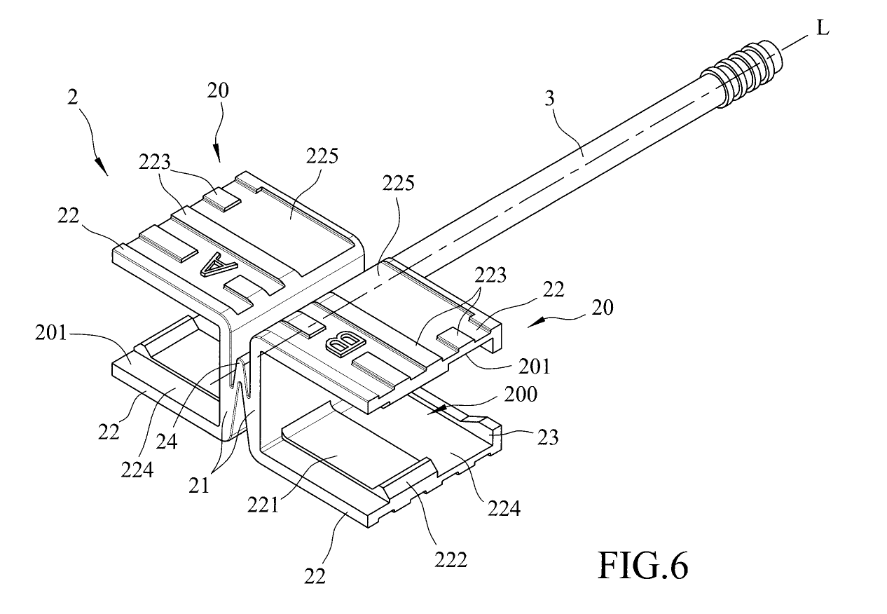

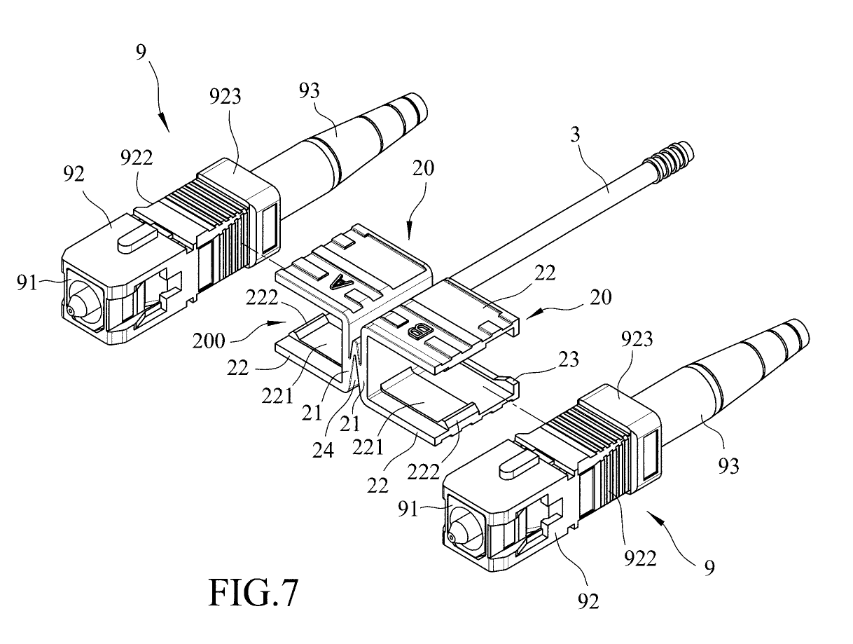

Referring to FIGS. 6 and 7, the second embodiment of the plug-in device is adapted for being sleeved onto two optical fiber connectors 9. The second embodiment has a structure similar to that of the first embodiment. The main difference between this embodiment and the previous embodiment resides in the structure of the main body 2. The main body 2 is formed with two receiving spaces 200, and has a connecting portion 24, and two mounting units 20 respectively connected to two opposite sides of the connecting portion 24. Each of the mounting units 20 has a side plate 21 fixedly connected to the connecting portion 24, two holding plates 22 spaced apart from each other, respectively and perpendicularly extending from two opposite ends of the side plate 21, and at least one end plate 23 extending perpendicularly from a rear end of one of the holding plates 22 toward the receiving space 200. In this embodiment, each of the mounting units 20 has two end plates 23 respectively extend from rear ends of the holding plates 22, and may be varied in other embodiments. The holding plates 22 of each of the mounting units 20 respectively have distal ends that cooperate to define a lateral opening 201 therebetween, which is in spatial communication with a respective one of the receiving spaces 200. Each of the receiving spaces 200 is surrounded by the side plate 21 and the holding plates 22 of a corresponding one of the mounting units 20. Each of the lateral openings 201 is spaced apart from the side plate 21 of a corresponding one of the mounting units 20, and is adapted to permit the sleeve body 92 of a respective one of the optical fiber connectors 9 to be inserted into the respective one of the receiving spaces 200 therethrough. With such configuration, the objective to augment plug-in ports can be achieved. The second embodiment has the same assembly procedure and the same advantages as those of the first embodiment, and will therefore not be further described herein.

In conclusion, with the configuration of the plug-in device, the operator can easily perform the operations of assembling the plug-in device to the optical fiber connector 9 or the optical fiber connectors 9, thereby facilitating the optical fiber connector 9 to be connected to or disconnected from the terminal unit or the delaying unit. The objective of the disclosure is therefore achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A plug-in device adapted for being sleeved onto an optical fiber connector, the optical fiber connector being connected to a terminal unit, and including a connector body that extends in a front-to-rear direction along an axis, and that is disposed for receiving at least one optical fiber, and a sleeve body that is sleeved on the connector body, said plug-in device comprising:
a main body adapted to removably hold the sleeve body of the optical fiber connector, and formed with a receiving space; and
a handle rod fixedly connected to and extending rearwardly from said main body, and adapted for being gripped by an operator,
wherein said main body has a side plate, and two holding plates spaced apart from each other, extending from two opposite ends of said side plate, and respectively having distal ends that cooperate to define a lateral opening therebetween, which is in spatial communication with said receiving space, said receiving space being surrounded by said side plate and said holding plates, said lateral opening being spaced apart from said side plate and being adapted to permit the sleeve body of the optical fiber connector to be inserted into said receiving space through said lateral opening during assembly of said plug-in device to the optical fiber connector.

2. (canceled)

3. The plug-in device as claimed in claim 1, the sleeve body of the optical fiber connector having a coupling portion that is disposed on a surrounding surface of the sleeve body, and a protrusion that protrudes from the surrounding surface of the sleeve body, and that is connected to and disposed behind the coupling portion, wherein:
said main body further has an end plate extending from a rear end of one of said holding plates toward said receiving space, each of said holding plates having an inner surface that faces said receiving space, a guiding portion that extends from said inner surface toward said receiving space, and a retaining portion that protrudes from one end of said guiding portion that is distal from said side plate toward said receiving space; and
said guiding portions of said holding plates and said end plate are adapted to confine the protrusion of the sleeve body thereamong such that, the coupling portion of the sleeve body is confined between said retaining portions of said base plates and said side plate.

4. The plug-in device as claimed in claim 3, wherein each of said holding plates of said main body further has an outer surface disposed opposite to a corresponding one of said inner surfaces, and a plurality of projections disposed on said outer surface, and spaced apart from each other along the axis.

5. The plug-in device as claimed in claim 3, wherein said guiding portions of said holding plates have different lengths along the axis.

6. A plug-in device adapted for being sleeved onto two optical fiber connectors, the optical fiber connectors being connected to a terminal unit, and each including a connector body that extends in a front-to-rear direction along an axis, and that is disposed for receiving at least one optical fiber, and a sleeve body that is sleeved on the connector body, said plug-in device comprising:
a main body adapted to removably hold the sleeve bodies of the optical fiber connectors, and formed with two receiving spaces; and
a handle rod fixedly connected to and extending rearwardly from said main body, and adapted for being gripped by an operator,
wherein said main body further has a connecting portion, and two mounting units respectively connected to two opposite sides of said connecting portion, each of said mounting units having a side plate that is fixedly connected to said connecting portion, and two holding plates that are spaced apart from each other, that extend from two opposite ends of said side plate, and that respectively have distal ends cooperating to define a lateral opening therebetween, which is in spatial communication with a respective one of said receiving spaces, each of said receiving spaces being surrounded by said side plate and said holding plates of a corresponding one of said mounting units, each of said lateral openings being spaced apart from said side plate of a corresponding one of said mounting units, and being adapted to permit the sleeve body of a respective one of the optical fiber connectors to be inserted into the respective one of said receiving spaces therethrough.

7. (canceled)

8. The plug-in device as claimed in claim 6, the sleeve body of each of the optical fiber connectors having a coupling portion that is disposed on a surrounding surface of the sleeve body, and a protrusion that protrudes from the surrounding surface of the sleeve body, and that is connected to and disposed behind the coupling portion, wherein:
each of said mounting units of said main body further has an end plate extending from a rear end of one of said holding plates toward said receiving space, each of said holding plates having an inner surface that faces said receiving space, a guiding portion that extends from said inner surface toward said receiving space, and a retaining portion that protrudes from one end of said guiding portion that is distal from said side plate toward said receiving space; and
said guiding portions of said holding plates and said end plate of a respective one of said mounting units are adapted to confine the protrusion of a corresponding one of the sleeve bodies thereamong such that, the coupling portion of the corresponding one of the sleeve bodies is confined between said retaining portions of said base plates and said side plate of each of said mounting units.

9. The plug-in device as claimed in claim 8, wherein each of said holding plates of each of said mounting units of said main body further has an outer surface disposed opposite to a corresponding one of said inner surfaces, and a plurality of projections disposed on said outer surface, and spaced apart from each other along the axis.

10. The plug-in device as claimed in claim 8, wherein said guiding portions of said holding plates of each of said mounting units have different lengths along the axis.
